(19) United States
(12) Patent Application Publication
(10) Pub. No.: US 2008/0211739 A1
(43) Pub. Date: Sep. 4, 2008

(54) PLASMA DISPLAY PANEL

(76) Inventors: Byoung-Min Chun, Suwon-si (KR); Kyoung-Doo Kang, Suwon-si (KR); Yong-Shik Hwang, Suwon-si (KR); Jae-Ik Kwon, Suwon-si (KR); Won-Ju Yi, Suwon-si (KR); Tae-Seung Cho, Suwon-si (KR); Young-Do Choi, Suwon-si (KR); Seok-Gyun Woo, Suwon-si (KR)

Correspondence Address: CHRISTIE, PARKER & HALE, LLP, PO BOX 7068, PASADENA, CA, 91109-7068, US

(21) Appl. No.: 11/971,824

(22) Filed: Jan. 9, 2008

(30) Foreign Application Priority Data
Jan. 10, 2007 (KR) 10-2007-0003072

(51) Int. Cl. G09G 3/28

(52) U.S. Cl. 345/60

(57) ABSTRACT

A PDP with improved durability is provided. The PDP includes a first substrate and a second substrate facing the first substrate. An electrode sheet is between the first substrate and the second substrate. The electrode sheet includes barrier ribs, a plurality of discharge cells, discharge electrodes for generating discharge in the discharge cells, and one or more through-holes. A sealant is disposed in the one or more through-holes for sealing the first substrate and the second substrate.

### CROSS-REFERENCE TO RELATED PATENT APPLICATIONS

This application claims priority to and the benefit of Korean Patent Application No. 10-2007-0003072, filed on Jan. 10, 2007, in the Korean Intellectual Property Office, the entire content of which is incorporated herein by reference.

### BACKGROUND OF THE INVENTION

1. Field of the Invention

The present invention relates to a plasma display panel, and more particularly, to a plasma display panel with improved durability.

2. Description of the Related Art

Plasma display devices using plasma display panels (PDPs), which are flat panel displays for displaying an image through a gas discharge, can be manufactured thin, with large screens, and provide improved image performance such as high brightness, high contrast, less image sticking, and a wide-range viewing angle. Accordingly, plasma display devices have attracted a considerable amount of attention as the next generation large-sized flat panel displays.

FIG. 1 is an exploded perspective view of a conventional PDP 100. The conventional PDP 100 includes a first substrate 101, sustain electrodes 106, 107 disposed on the first substrate 101, a first dielectric layer 109 covering the sustain electrodes 106, 107, a protective layer 111 disposed on the first dielectric layer 109, a second substrate 115 facing the first substrate 101, address electrodes 117 disposed parallel to each other on the second substrate 115, a second dielectric layer 113 covering the address electrodes 117, barrier ribs 114 formed on the second dielectric layer 113, and phosphor layers 110 formed on a top surface of the second dielectric layer 113 and on sidewalls of the barrier ribs 114.

The conventional PDP 100 suffers from low luminous efficiency because a considerable amount (approximately 40%) of visible light emitted by the phosphor layers 110 is absorbed by the sustain electrodes 106, 107, the first dielectric layer 109, and the protective layer 111, which are disposed on a bottom surface of the first substrate 101. To solve the problem, attempts have been made to improve brightness and luminous efficiency by providing discharge electrodes on the sidewalls of the barrier ribs 114 in order to generate a discharge. However, it is difficult to manufacture the PDP having the above-described structure. Also, when the first and second substrates 101, 115 are sealed, the sealed portions in the conventional PDP 100 are weak to external pressure or heat.

### SUMMARY OF THE INVENTION

The present invention provides a plasma display panel in which sealed portions between facing substrates have improved durability against external impact. In an exemplary embodiment of the present invention, a PDP is provided having a first substrate and a second substrate facing the first substrate. An electrode sheet is between the first substrate and the second substrate. The electrode sheet includes barrier ribs, a plurality of discharge cells, discharge electrodes for generating discharge in the discharge cells, and one or more through-holes. A sealant is disposed in the one or more through-holes for sealing the first substrate and the second substrate.

In an exemplary embodiment of the present invention, the PDP further includes a first sealing member for sealing the first substrate and the electrode sheet, and a second sealing member for sealing the second substrate and the electrode sheet.

In an exemplary embodiment of the present invention, the electrode sheet is divided into a discharge region in which discharge occurs, and a non-discharge region surrounding the discharge region, and the one or more through-holes are within the non-discharge region.

In an exemplary embodiment of the present invention, the sealant may be frit glass.

In an exemplary embodiment of the present invention, a periphery of the electrode sheet is exposed on at least one side of the first substrate or the second substrate.

In an exemplary embodiment of the present invention, terminals of the discharge electrodes may extend on the side of the electrode sheet exposed on the at least one side of the first substrate or the second substrate.

In an exemplary embodiment of the present invention, the through-holes are along the first sealing member or the second sealing member.

In an exemplary embodiment of the present invention, the sealant may be the same material as the first sealing member or the second sealing member.

In an exemplary embodiment of the present invention, the electrode sheet has at least one unexposed side on any sides of the first substrate and the second substrate. A third sealing member is beyond the at least one unexposed side of the electrode sheet for sealing the first substrate and the second substrate.

In an exemplary embodiment of the present invention, the sealant, the first sealing member, and the second sealing member may be the same material.

In an exemplary embodiment of the present invention, grooves are in the first substrate facing the discharge cells and phosphor layers are in the grooves.

In an exemplary embodiment of the present invention, the discharge electrodes include a first discharge electrode and a second discharge electrode buried in the barrier ribs and spaced apart from each other in a direction perpendicular to the first substrate. The first discharge electrodes and the second discharge electrodes extend crossing each other. The first discharge electrodes and the second discharge electrodes at least partially surround the discharge cells arranged in directions in which the first discharge electrodes and the second discharge electrodes extend.

In an exemplary embodiment of the present invention, the discharge electrodes include a first discharge electrode and a second discharge electrode buried in the barrier ribs and spaced apart from each other in a direction perpendicular to the first substrate. The first discharge electrodes and the second discharge electrodes extend parallel to each other. The first discharge electrodes and the second discharge electrodes at least partially surround the discharge cells arranged in directions in which the first discharge electrodes and the second discharge electrodes extend.

In an exemplary embodiment of the present invention, address electrodes are buried in the barrier ribs and perpendicularly spaced apart from the discharge electrodes. The address electrodes extending to cross the discharge electrodes. The address electrodes at least partially surround the discharge cells arranged in a direction in which the address electrodes extend.

### BRIEF DESCRIPTION OF THE DRAWINGS

FIG. 1 is an exploded perspective view of a conventional PDP.

FIG. 2 is an exploded perspective view of a PDP according to an exemplary embodiment of the present invention.

FIG. 3 is a plan view in a direction of arrow A of the PDP of FIG. 2 according to an exemplary embodiment of the present invention.

FIG. 4 is a partial cross-sectional view taken along line IV-IV of the PDP of FIG. 3 according to an exemplary embodiment of the present invention.

FIG. 5 is a partial cross-sectional view taken along line V-V of the PDP of FIG. 3 according to an exemplary embodiment of the present invention.

FIG. 6 is an enlarged perspective view of the PDP of FIG. 2 according to an exemplary embodiment of the present invention.

FIG. 7 is a perspective view illustrating discharge cells and first and second discharge electrodes of the PDP of FIG. 6 according to an exemplary embodiment of the present invention.

FIG. 8 is an enlarged perspective view of a modification of the PDP illustrated in FIG. 6 according to an exemplary embodiment of the present invention.

FIG. 9 is a perspective view illustrating discharge cells and first and second discharge electrodes of the PDP of FIG. 8 according to an exemplary embodiment of the present invention.

FIG. 10 is a plan view of a PDP according to another exemplary embodiment of the present invention.

FIG. 11 is a partial cross-sectional view taken along line XI-XI of the PDP of FIG. 10 according to another exemplary embodiment of the present invention.

### DETAILED DESCRIPTION

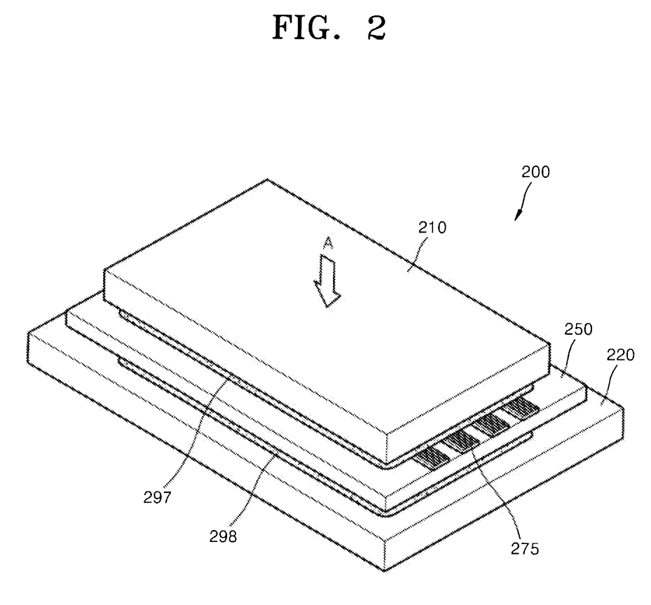

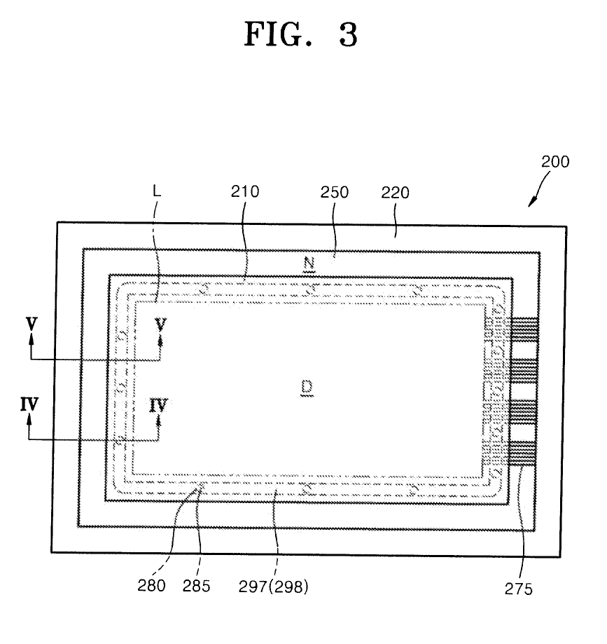

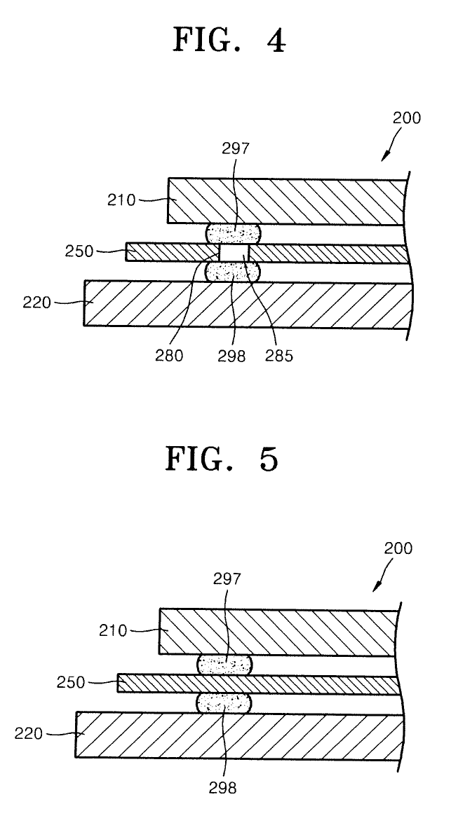

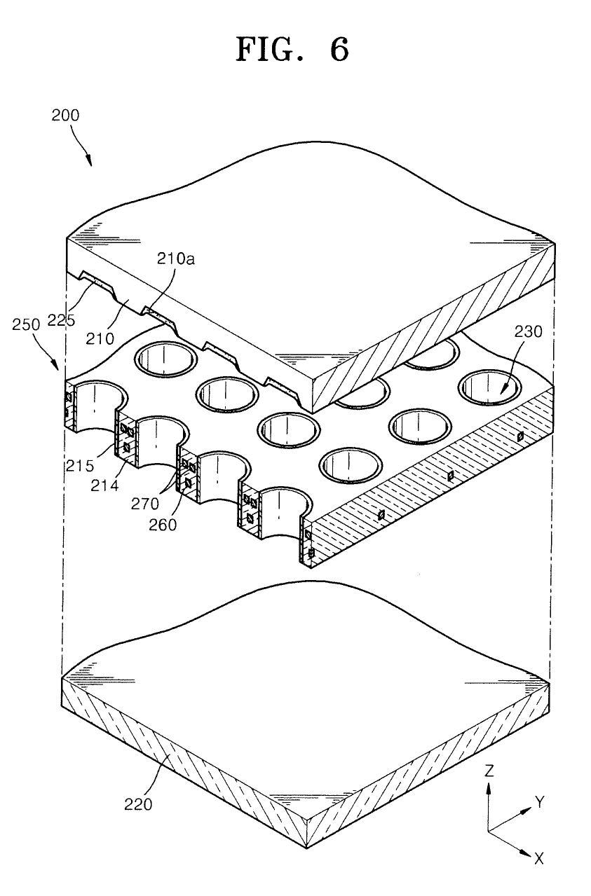

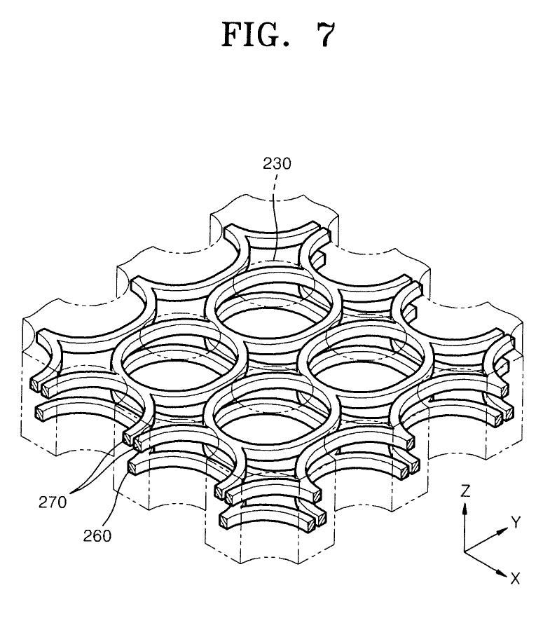

FIG. 2 is a perspective view of a PDP 200 according to an exemplary embodiment of the present invention. FIG. 3 is a plan view in a direction of arrow A of the PDP 200 of FIG. 2 according to an exemplary embodiment of the present invention. FIG. 4 is a partial cross-sectional view taken along line IV-IV of the PDP 200 of FIG. 3 according to an exemplary embodiment of the present invention. FIG. 5 is a partial cross-sectional view taken along line V-V of the PDP 200 of FIG. 3 according to an exemplary embodiment of the present invention. FIG. 6 is an enlarged perspective view of the PDP 200 of FIG. 2 according to an exemplary embodiment of the present invention. FIG. 7 is a perspective view illustrating discharge cells and first and second discharge electrodes of the PDP 200 of FIG. 6 according to an exemplary embodiment of the present invention.

The PDP 200 includes a first substrate 210, a second substrate 220, an electrode sheet 250, a first sealing member 297, a second sealing member 298, and phosphor layers 225.

Referring to FIG. 2 and FIG. 6, the first substrate 210 is a glass substrate mainly made of glass having excellent light transmittance. In order to reduce reflected luminance and improve bright room contrast, the first substrate 210 may be colored. The second substrate 220 is spaced an interval (e.g., a predetermined interval) from the first substrate 210 so as to face the first substrate 210, and a plurality of discharge cells 230 are defined between the first substrate 210 and the second substrate 220. The discharge cells 230 are places in which a discharge is substantially generated. The second substrate 220 is made of a material with high light transmittance, such as glass, and may be colored like the first substrate 210.

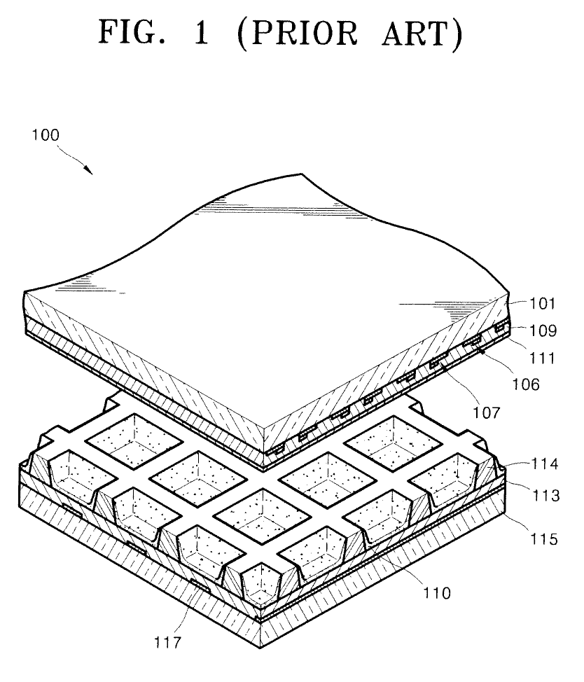

Visible light generated in the discharge cells 230 may be outwardly emitted through the first substrate 210. A conventional PDP 100 as seen in FIG. 1 has low visible light transmittance because sustain electrodes 106, 107, a first dielectric layer 109, and a protective layer 111 are disposed on a first substrate 101 of the conventional PDP 100. However, because only the phosphor layers 225 are disposed on the first substrate 210, the PDP 200 according to the present exemplary embodiment of the present invention can significantly improve visible light transmittance.

Referring to FIG. 6, the electrode sheet 250 includes barrier ribs 214 defining the plurality of discharge cells 230. The discharge cells 230 defined by the barrier ribs 214 have a circular cross-section in FIG. 6, but the present exemplary embodiments are not limited thereto. Specifically, instead of the circular cross-section, the discharge cells 230 defined by the barrier ribs 214 may have a polygonal cross-section, such as a triangular, quadrangular, or pentagonal cross-section, or an elliptical cross-section.

Referring to FIG. 3, the electrode sheet 250 is divided into a discharge region D in which the discharge cells 230 are arranged and discharge is substantially generated, and a non-discharge region N surrounding the discharge region D and including terminals 275. A boundary between the discharge region D and the non-discharge region N of the electrode sheet 250 is indicated by a dash-dot-dot line L.

Referring to FIG. 6 and FIG. 7, the electrode sheet 250 further includes a plurality of discharge electrode pairs 260, 270, and each of the discharge electrode pairs 260, 270 includes a first discharge electrode 260 and a second discharge electrode 270. The first discharge electrodes 260 and the second discharge electrodes 270 of the plurality of discharge electrode pairs are buried in the barrier ribs 214. The first discharge electrodes 260 and the second discharge electrodes 270, which are disposed in pairs, generate discharge in the discharge cells 230. The first discharge electrodes 260 extend to respectively surround the discharge cells 230 that are arranged in a first direction (X direction).

The second discharge electrodes 270 extend to respectively surround the discharge cells 230 arranged in a second direction (Y direction) perpendicular to the first direction (X direction) in which the first discharge electrodes 260 extend. The first and second discharge electrodes 260, 270 are buried in the barrier ribs 214 so as to be spaced apart from each other in a third direction (Z direction) perpendicular to the first substrate 210. The second discharge electrodes 270 are closer to the first substrate 210 than the first discharge electrodes 260, but the present exemplary embodiment is not limited thereto.

The PDP 200 according to the present exemplary embodiment has a dual-electrode structure. Hence, one of the first discharge electrode 260 and the second discharge electrode 270 acts as a scan or sustain electrode, and the other one acts as an address or sustain electrode.

Referring to FIG. 6 and FIG. 7, because the first discharge electrodes 260 and the second discharge electrodes 270 are buried in the barrier ribs 214, visible light transmittance is not reduced. Accordingly, the first discharge electrodes 260 and the second discharge electrodes 270 may be formed of conductive metal, such as aluminum or copper, because conductive metal is characterized with a low voltage drop, and thus the first discharge electrodes 260 and the second discharge electrodes 270 can transmit signals stably.

The barrier ribs 214 prevent the first discharge electrodes 260 and the second discharge electrodes 270 from electrically coupling to each other, and also prevent the first and second discharge electrodes 260, 270 from being damaged by the collision of cations and electrons thereto. In addition, the barrier ribs 214 induce and accumulate wall charges. Accordingly, the barrier ribs 214 are formed of a dielectric material.

The electrode sheet 250 may further include protective layers 215 formed on sidewalls of the barrier ribs 214. The protective layers 215 prevent plasma particles from damaging the barrier ribs 214. Also, the protective layers 215 emit secondary electrons to reduce a discharge voltage. The protective layers 215 may be formed by depositing magnesium oxide (MgO) on the sidewalls of the barrier ribs 214.

Grooves 210a are formed in the first substrate 210 facing the discharge cells 230. The grooves 210a may correspond to the discharge cells 230 in a one-to-one fashion, or one groove 210a may correspond to a plurality of discharge cells 230. The thickness of the first substrate 210 decreases due to the grooves 210a, thereby improving visible light transmittance of the PDP 200.

Red, green, and blue phosphor layers 225 are coated in the grooves 210a. The area of the phosphor layers 225 increases due to the grooves 210a, thereby improving brightness and luminous efficiency of the PDP 200. The phosphor layers 225 generate visible light when excited by ultraviolet rays. The red phosphor layers 225 include phosphor such as Y(V,P)O₄:Eu, the green phosphor layers 225 include phosphor such as Zn₂SiO₄:Mn or YBO₃:Tb, and the blue phosphor layers 225 include phosphor such as BAM:Eu.

Referring to FIG. 4 and FIG. 5, the first sealing member 297 is disposed between the electrode sheet 250 and the first substrate 210. The first sealing member 297 is formed along and within the non-discharge region N of the electrode sheet 250, and seals the first substrate 210 and the electrode sheet 250. The second sealing member 298 is disposed between the electrode sheet 250 and the second substrate 220 along and within the non-discharge region N, and seals the second substrate 220 and the electrode sheet 250. The discharge cells 230 are hermetically sealed from the outside by the first sealing member 297 and the second sealing member 298. The first sealing member 297 and the second sealing member 298 may be made of frit glass. The discharge cells 230 are filled with a discharge gas, such as Ne, Xe, or a gas mixture thereof.

The electrode sheet 250 has through-holes 280 formed along the edge of the non-discharge region N so as to be within the non-discharge region N. While each of the through-holes 280 has a circular shape as depicted in FIG. 3, the present exemplary embodiment is not limited thereto, and thus the through-holes 280 may have a polygonal shape. Sealants 285 are disposed in the through-holes 280. The first substrate 210 and the second substrate 220 are perpendicularly connected to each other due to the sealants 285 that may be formed of frit glass. Referring to FIG. 4, the first substrate 210 and the second substrate 220 may be connected to each other by the sealants 285 disposed in the through-holes 280. Because the through-holes 280 are formed along the edge of the first and second sealing members 297, 298, the sealants 285 are in contact with the first sealing member 297 and the second sealing member 298 in FIG. 4, but the present exemplary embodiment is not limited thereto. That is, the sealants 285 may be applied outside the first and second sealing members 297, 298 so as to not contact the first and second sealing members 297, 298. Referring to FIG. 5, in portions where the through-holes 280 are not formed, the first substrate 210 and the second substrate 220 are respectively sealed to the electrode sheet 250 by the first sealing member 297 and the second sealing member 298. In this structure, the risk that the PDP 200 may be damaged by external impact can be reduced. That is, if the first substrate 210 and the electrode sheet 250 are sealed only by the first sealing member 297 and the second substrate 220 and the electrode sheet 250 are sealed only by the second sealing member 298, sealed portions between the first substrate 210 and the electrode sheet 250 may be damaged by external impact, and the sealed portions between the second substrate 220 and the electrode sheet 250 may also be damaged by external impact. Furthermore, if any one of the sealed portions between the first substrate 210 and the electrode sheet 250 and between the second substrate 220 and the electrode sheet 250 is damaged, the PDP 200 may malfunction.

However, because the first substrate 210 and the second substrate 220 are perpendicularly sealed by the sealants 285, the PDP 200 according to the present exemplary embodiment is improved in terms of durability.

The electrode sheet 250 extends so as to be exposed on at least one side of the first substrate 210 or the second substrate 220. The terminals 275 are formed on the exposed side of the electrode sheet 250. In the structure, there always exists a 3-layered area where the first substrate 210 and the second substrate 220 are formed with the electrode sheet 250 between the first substrate 210 and the second substrate 220. However, sealed portions in the 3-layered area are liable to be damaged by external force as described above. However, according to the present exemplary embodiment, because the through-holes 280 are formed in the electrode sheet 250 and the sealants 285 are disposed in the through-holes 280, the first substrate 210 is directly connected to the second substrate 220 by the sealants 285. As a result, the PDP 200 can be improved in terms of durability against external impact.

The through-holes 280 of the electrode sheet 250 may be formed along the first sealing member 297 or the second sealing member 298. In the present exemplary embodiment, the sealants 285 may be formed of the same material as the first sealing member 297 or the second sealing member 298 at the same time when the first sealing member 297 or the second sealing member 298 is formed. Also, the first sealing member 297, the second sealing member 298, and the sealants 285 may be formed of the same material. Specifically, the first sealing member 297, the second sealing member 298, and the sealants 285 may be made of the same frit glass as shown in FIG. 4.

The terminals 275 are formed on the side of the electrode sheet 250 within the non-discharge region N, which is exposed on at least one side of the first substrate 210 or the second substrate 220. The terminals 275 can be electrically connected to signal transmission members for connecting the PDP 200 to a driving circuit. The terminals 275 and the signal transmission members are connected to each other by an anisotropic conductive film. The signal transmission members may be flexible printed cables (FPCs), tape carrier packages (TCPs), or chip-on-films (COFs).

A method of driving the PDP 200 constructed as described above will now be explained. First, an address discharge occurs between the first discharge electrode 260 and the second discharge electrode 270, and thus a discharge cell 230 where a sustain discharge will be generated is selected. When an alternating current (AC) sustain voltage is applied between the first discharge electrode 260 and the second discharge electrode 270 of the selected discharge cell 230, the sustain discharge occurs between the first discharge electrode 260 and the second discharge electrode 270 so as to excite the discharge gas. When the energy level of the excited discharge gas is lowered, ultraviolet rays are emitted. Then, the ultraviolet rays excite the phosphor layers 225. When the energy level of the excited phosphor layers 225 is lowered, visible light is emitted, thereby forming an image.

The conventional PDP 100 has a narrow discharge area because a sustain discharge between the sustain electrodes 106, 107 occurs in a direction parallel to the first substrate 101. However, the PDP 200 of the present exemplary embodiment of the present invention has a relatively wider discharge area and generates sustain discharge at all sides of the barrier ribs 214. Also, in the present exemplary embodiment, the sustain discharge is generated in a closed loop-manner along the sidewalls of the barrier ribs 214 and gradually expands toward the center of each of the discharge cells 230. Consequently, the area where the sustain discharge occurs increases. Also, because the sustain discharge is concentrated in the center of the discharge cell 230, ion sputtering of the phosphor layers 225 can be prevented. Accordingly, even though the same image can be displayed for a long time, image sticking is avoided. In addition, even if the electrode sheet 250 is partially exposed on at least one side of the first substrate 210 or the second substrate 220, the PDP 200 is improved in terms of durability against external impact because the through-holes 280 are formed in the electrode sheet 250 and the first substrate 210 and the second substrate 220 are connected to each other by the sealants 285 disposed in the through-holes 280.

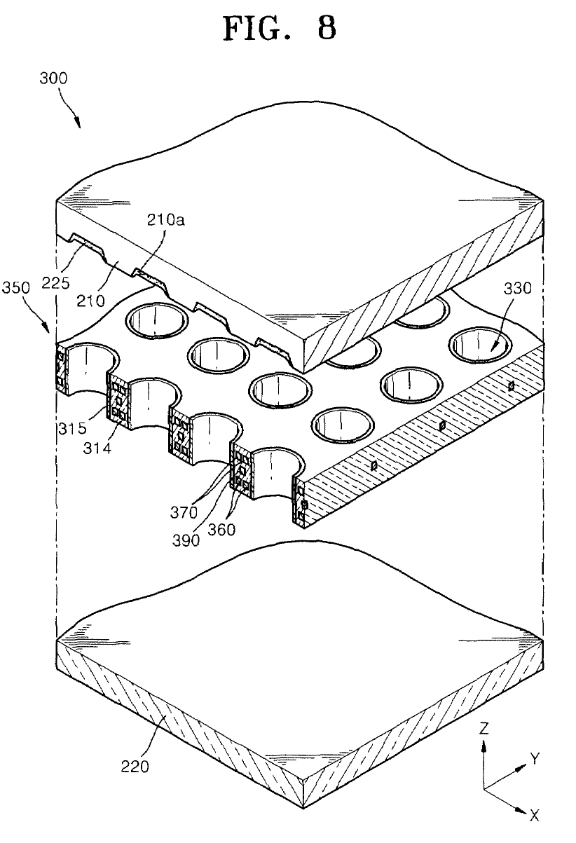

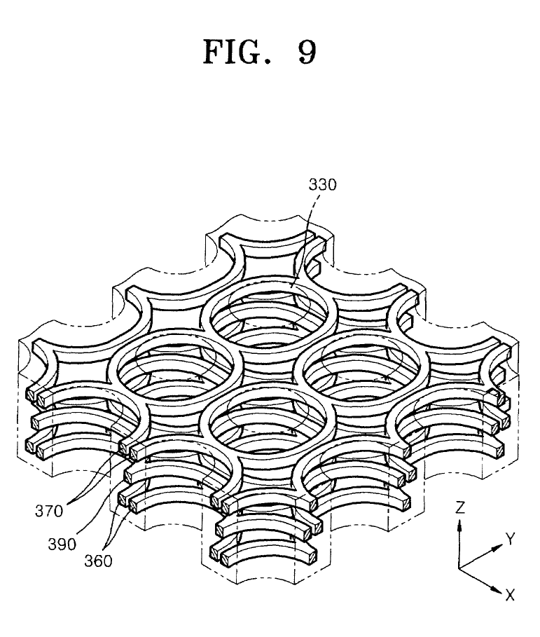

FIG. 8 is an enlarged perspective view of a modification of the PDP illustrated in FIG. 6 according to an exemplary embodiment of the present invention. FIG. 9 is a perspective view illustrating discharge cells and first and second discharge electrodes of the PDP 300 of FIG. 8 according to an exemplary embodiment of the present invention. The following explanation is accomplished by focusing on the difference between the PDP 200 of FIG. 6 and the PDP 300 of FIG. 8. The same reference numerals denote the same elements.

The PDP 300 includes a first substrate 210, a second substrate 220, an electrode sheet 350, and phosphor layers 225. Referring to FIG. 8, the electrode sheet 350 of the PDP 300 includes a plurality of barrier ribs 314 defining a plurality of discharge cells 330. The barrier ribs 314 are made of a dielectric material. The electrode sheet 350 further includes a plurality of discharge electrode pairs. Each of the discharge electrode pairs includes a first discharge electrode 360 and a second discharge electrode 370. Referring to FIG. 8 and FIG. 9, the first discharge electrodes 360 and the second discharge electrodes 370 are buried in the barrier ribs 314 so as to be spaced apart from each other in a third direction (Z direction) perpendicular to the first substrate 210. The first discharge electrodes 360 and the second discharge electrodes 370, which are disposed in pairs, generate discharge in the discharge cells 330. The first discharge electrodes 360 and the second discharge electrodes 370, which are parallel to each other, extend to surround the discharge cells 330 arranged in a second direction (Y direction).

The electrode sheet 350 further includes address electrodes 390 crossing the first and second discharge electrodes 360, 370. The address electrodes 390 are buried in the barrier ribs 314 so as to be spaced apart from the first and second discharge electrodes 360, 370 in the third direction (Z direction) perpendicular to the first substrate 210. The address electrodes 390 extend to surround the discharge cells 330 that are arranged in a first direction (X direction). Referring to FIG. 8, in order to reduce an address discharge voltage, the second discharge electrodes 370, the address electrodes 390, and the first discharge electrodes 360 are sequentially disposed relative to the first substrate 210 in the barrier ribs 314. However, the present exemplary embodiment is not limited thereto, and the address electrodes 390 may be closest to or farthest from the first substrate 210, or the address electrodes 390 may be formed on the second substrate 220. The address electrodes 390 facilitate sustain discharge between the first discharge electrodes 360 and the second discharge electrodes 370. Specifically, the address electrodes 390 reduce a firing discharge voltage. The first discharge electrodes 360 act as scan electrodes and the second discharge electrodes 370 act as sustain electrodes in the PDP 300 of FIG. 8, but the present exemplary embodiment is not limited thereto. Also, the electrode sheet 350 further includes protective layers 315 coated on sidewalls of the barrier ribs 314.

A method of driving the PDP 300 constructed as described above will now be explained. First, address discharge occurs between the first discharge electrodes 360 and the address electrodes 390, and thus a discharge cell 330 where sustain discharge will be generated is selected. When an AC sustain voltage is applied between the first discharge electrodes 360 and the second discharge electrodes 370 of the selected discharge cell 330, sustain discharge occurs between the first discharge electrode 360 and the second discharge electrode 370 so as to excite a discharge gas. When the energy level of the excited discharge gas is lowered, ultraviolet rays are emitted so as to excite the phosphor layers 225. When the energy level of the excited phosphor layers 225 is lowered, visible light is emitted, and thereby forms an image.

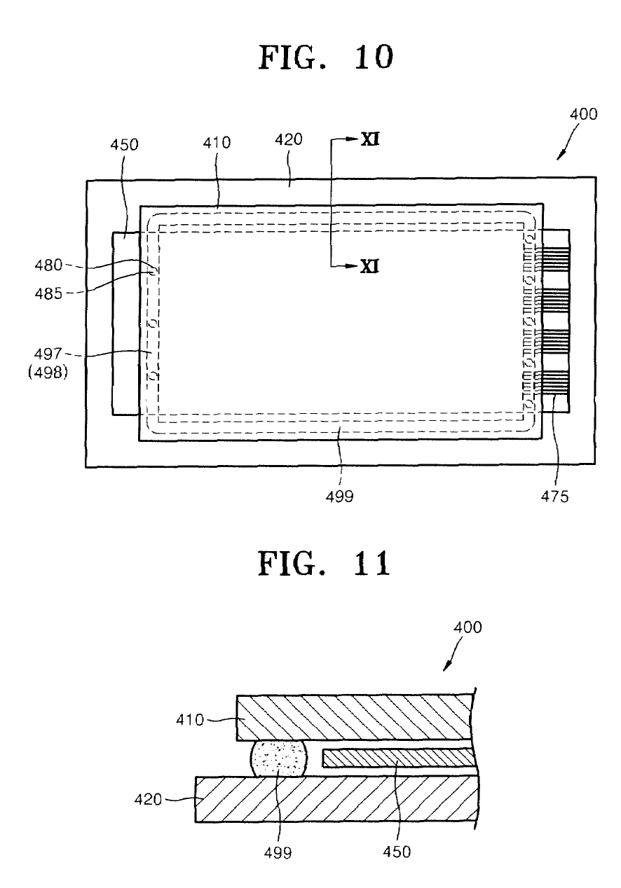

FIG. 10 is a plan view of a PDP 400 according to another exemplary embodiment of the present invention. FIG. 11 is a partial cross-sectional view taken along line XI-XI of the PDP 400 of FIG. 10 according to another exemplary embodiment of the present invention. The following explanation focuses on the difference between the PDP 200 of FIG. 2 and the PDP 400 of FIG. 10. The same reference numerals denote the same elements.

The PDP 400 includes a first substrate 410, a second substrate 420, and an electrode sheet 450. The first substrate 410 and the second substrate 420 are conventionally formed of glass, and may be colored in order to improve contrast.

The electrode sheet 450 has at least one side that is not exposed by any sides of the first substrate 410 and the second substrate 420. While upper and lower sides of the electrode sheet 450 are covered by the first substrate 410 so as to not be exposed in FIG. 10, the electrode sheet 450 is not limited thereto. That is, only one side of the electrode sheet 450 may be covered by the first and second substrates 410, 420 so as to not be exposed. The terminals 475 are formed on the exposed side of the electrode sheet 450.

Referring to FIG. 10, a third sealing member 499 is disposed outside the unexposed upper and lower sides of the electrode sheet 450. The third sealing member 499 is applied between the first substrate 410 and the second substrate 420 and seals the first substrate 410 and the second substrate 420. The third sealing member 499 may be made of frit glass. Through-holes 480 are formed on sides of the electrode sheet 450 that is exposed on at least one side of the first substrate 410 and the second substrate 420. Specifically, the through-holes 480 are formed in left and right sides of the electrode sheet 450 in FIG. 10. Sealants 485 are disposed in the through-holes 480 to perpendicularly connect the first substrate 410 and the second substrate 420, and thereby improve durability of the PDP 400. Because the through-holes 480 are formed along the edge of the first and second sealing members 497, 498, the sealants 485 are in contact with the first sealing member 497 and the second sealing member 498, but the present exemplary embodiment is not limited thereto. That is, the sealants 485 may be applied outside the first and second sealing members 497, 498 so as to not contact the first and second sealing members 497, 498. Also, the third sealing member 499 is disposed beyond the sides of the electrode sheet 450 that is not exposed to the first and second substrates 410, 420 in order to directly connect the first substrate 410 and the second substrate 420, and thereby further improve durability of the PDP 400.

A method of driving the PDP 400 is the same as described above, and thus an explanation of the method of driving the PDP 400 will not be given. Also, the modification of the PDP 200 of FIG. 2 as illustrated by the PDP 300 can be applied to the PDP 400 of FIG. 10.

As described above, the PDP according to the present invention can be improved in terms of durability.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A plasma display panel comprising:
a first substrate and a second substrate facing the first substrate;
an electrode sheet between the first substrate and the second substrate, the electrode sheet including barrier ribs, a plurality of discharge cells, discharge electrodes for generating discharge in the discharge cells, and one or more through-holes; and
a sealant disposed in the one or more through-holes for sealing the first substrate and the second substrate.

2. The plasma display panel of claim 1, further comprising:
a first sealing member for sealing the first substrate and the electrode sheet; and
a second sealing member for sealing the second substrate and the electrode sheet.

3. The plasma display panel of claim 1, wherein the electrode sheet is divided into a discharge region in which discharge occurs, and a non-discharge region surrounding the discharge region,
wherein the one or more through-holes are within the non-discharge region.

4. The plasma display panel of claim 1, wherein the sealant comprises frit glass.

5. The plasma display panel of claim 1, wherein a periphery of the electrode sheet is exposed on at least one side of the first substrate or the second substrate.

6. The plasma display panel of claim 5, wherein terminals of the discharge electrodes extend on the side of the electrode sheet exposed on the at least one side of the first substrate or the second substrate.

7. The plasma display panel of claim 2, wherein the through-holes are along the first sealing member or the second sealing member.

8. The plasma display panel of claim 2, wherein the sealant comprises the same material as the first sealing member or the second sealing member.

9. The plasma display panel of claim 2, wherein the electrode sheet has at least one unexposed periphery on any sides of the first substrate and the second substrate, wherein the plasma display panel further comprises:
a third sealing member beyond the at least one unexposed periphery of the electrode sheet for sealing the first substrate and the second substrate.

10. The plasma display panel of claim 9, wherein the sealant, the first sealing member, and the second sealing member comprise the same material.

11. The plasma display panel of claim 1, further comprising:
grooves in the first substrate facing the discharge cells; and
phosphor layers in the grooves.

12. The plasma display panel of claim 1, wherein the discharge electrodes include a first discharge electrode and a second discharge electrode buried in the barrier ribs and spaced apart from each other in a direction perpendicular to the first substrate,
wherein the first discharge electrodes and the second discharge electrodes extend crossing each other,
wherein the first discharge electrodes and the second discharge electrodes at least partially surround the discharge cells arranged in directions in which the first discharge electrodes and the second discharge electrodes extend.

13. The plasma display panel of claim 1, wherein the discharge electrodes include a first discharge electrode and a second discharge electrode buried in the barrier ribs and spaced apart from each other in a direction perpendicular to the first substrate,
wherein the first discharge electrodes and the second discharge electrodes extend parallel to each other,
wherein the first discharge electrodes and the second discharge electrodes at least partially surround the discharge cells arranged in directions in which the first discharge electrodes and the second discharge electrodes extend.

14. The plasma display panel of claim 13, further comprising:
address electrodes buried in the barrier ribs and perpendicularly spaced apart from the discharge electrodes, the address electrodes extending to cross the discharge electrodes,
wherein the address electrodes at least partially surround the discharge cells arranged in a direction in which the address electrodes extend.

15. A method of sealing a plasma display panel, comprising:
positioning a first substrate and a second substrate facing the first substrate;
disposing an electrode sheet between the first substrate and the second substrate, the electrode sheet including barrier ribs, a plurality of discharge cells, and discharge electrodes for generating discharge in the discharge cells;
forming one or more through-holes in the electrode sheet; and
sealing the first substrate and the second substrate by disposing a sealant in the one or more through-holes to make contact with the first substrate and the second substrate.

16. The method as claimed in claim 15, wherein the electrode sheet is divided into a discharge region in which discharge occurs, and a non-discharge region surrounding the discharge region,
wherein the one or more through-holes are formed within the non-discharge region.

17. The method as claimed in claim 16, wherein the sealant comprises frit glass.
